(19) United States
(12) Patent Application Publication
(10) Pub. No.: US 2008/0301997 A1
(43) Pub. Date: Dec. 11, 2008

(54) Technical fishing garment

(76) Inventor: Steve Tempini, Fairfield, CT (US)

Correspondence Address: McCARTER & English, LLP;Financial Centre, Suite 304A, 695 East Main Street, Stamford, CT, 06901-2183, US

(21) Appl. No.: 11/810,376

(22) Filed: Jun. 5, 2007

(51) Int. Cl. A01K 97/10; A41D 1/08

(52) U.S. Cl. 43/21.2; 2/69; 43/4

(57) ABSTRACT

The present disclosure provides for systems/designs for an advantageous fishing garment that facilitates ready access to fish fighting articles or gear. A fishing garment design that includes attachment features for releasably securing fish fighting articles or gear to the fishing garment design is disclosed. The present disclosure provides for a fishing garment design that includes attachment features for releasably securing fish fighting articles or gear to the fishing garment design, and where the fish fighting articles or gear are easily adjusted by the user once the fighting articles or gear are secured onto the fishing garment design. The disclosed fishing garment design is particularly adapted for use in connection with big-game fishing, e.g., sportfishing, salt and freshwater offshore fishing, billfish fishing, tuna fishing, sharkfishing or the like.

### BACKGROUND

1. Technical Field

The present disclosure is directed to an advantageous fishing garment system/design that facilitates ready access to fish fighting articles or gear and, more particularly, to a fishing garment design that includes attachment features for releasably securing fish fighting articles or gear to the fishing garment design. The disclosed fishing garment design has particular application for big-game fishing, e.g., sportfishing, salt and freshwater offshore fishing, billfish fishing, tuna fishing, sharkfishing or the like.

2. Background Art

Fish fighting articles or gear (e.g., fighting belts, fighting harnesses or the like) used by fishermen to fight fish are known. In general, when a fisherman has a fish on the line, the fisherman sometimes may employ fighting articles or gear in order to help the fisherman retrieve the fish. In general, the fighting articles or gear are typically secured around the fisherman's body by securing means. Generally, the fisherman would then releasably rest, secure or place the fishing rod or pole on or in a receiving portion of the fighting articles or gear in order to help the fisherman retrieve the fish.

Fish fighting articles or gear may take many forms. Fish fighting articles or gear are made out of a variety of materials, and the fighting articles or gear may have various forms of securing means. Thus, as is readily apparent, fish fighting articles or gear is highly specialized in the fishing industry.

In various fishing activities, it is desirable to have fighting articles or gear that is easily secured or unsecured around the fisherman's body. In addition, in various fishing activities, it is desirable to have fighting articles or gear that is easily adjustable once secured around the fisherman's body. For example, fishermen are frequently confronted with the need to secure or unsecure fighting articles or gear around their body in a short period of time under adverse conditions (e.g., while standing on a boat that is in motion and/or rocking; attempting to secure or unsecure the fighting gear with one arm while the other arm is engaged in some other activity (e.g., holding the fishing pole that is hooked on to a fish); attempting to adjust the belt length, straps and/or securing means of the fighting gear with one arm while the other arm is engaged in some other activity; attempting to secure or unsecure the fighting gear in adverse weather conditions). However, current practice with fish fighting articles or gear allows for a risk that a fisherman will experience difficulty in securing or unsecuring the fighting articles or gear around the fisherman's body, and it also allows for a risk that the fighting articles or gear will not be easily adjusted once secured around the fisherman's body.

Thus, despite efforts to date, a need remains for systems/designs for fish fighting articles or gear that are easily secured and/or unsecured around the fisherman's body. A need also remains for systems/designs for fish fighting articles or gear that are easily adjusted after the fighting articles or gear is secured around the fisherman's body.

These and other needs are satisfied by the disclosed fishing garment system/design, as described in detail herein below.

### SUMMARY

The present disclosure provides for an advantageous fishing garment system/design that facilitates ready access to fish fighting articles or gear and, more particularly, to a fishing garment design that includes attachment features for releasably securing fish fighting articles or gear to the fishing garment design. The disclosed fishing garment design has particular application for big-game fishing, e.g., sportfishing, salt and freshwater offshore fishing, billfish fishing, tuna fishing, sharkfishing or the like.

The present disclosure provides for a garment, including at least one garment surface, at least one fighting belt material secured with respect to at least one portion of the at least one garment surface, a first end fastener fastened to the at least one fighting belt material, a second end fastener fastened to the at least one fighting belt material, and each of the first and second end fasteners configured and dimensioned to releasably fasten to a fish fighting article. The present disclosure also provides for a garment wherein the at least one garment surface is associated with a garment selected from the group consisting of a pair of shorts, pants, overalls, bibs and capris.

The present disclosure also provides for a garment wherein the form of the at least one fighting belt material is selected from the group consisting of nylon, braided nylon, polypropylene, polyester, polyethylene, leather, cotton and combinations thereof. The present disclosure also provides for a garment wherein the first and second end fasteners are selected from the group consisting of D-rings, releasable snap-on fasteners, releasable clip-on fasteners, releasable button-on fasteners, zip-on fasteners, releasable strap-on fasteners, Velcro® fasteners and combinations thereof.

The present disclosure also provides for a garment wherein the fish fighting article is selected from the group consisting of a releasable fish fighting plate, releasable fish fighting harness, releasable fish fighting belt, releasable fish fighting belt material, releasable fishing rod receiving portion, and releasable fish fighting gimbal. In one embodiment, the present disclosure also provides for a garment wherein the fish fighting article is a releasable fish fighting plate, and wherein the releasable fish fighting plate further includes a plastic fishing rod receiving portion, and wherein the plastic fishing rod receiving portion includes a gimbal portion.

In one embodiment, the present disclosure also provides for a garment further including a first recessed pocket positioned to allow the first end fastener to be tucked into the first recessed pocket, and a second recessed pocket positioned to allow the second end fastener to be tucked into the second recessed pocket.

The present disclosure also provides for a garment wherein the at least one garment surface is a waistband, and wherein the at least one fighting belt material is secured with respect to the back and side portions of the waistband. In one embodiment, the present disclosure also provides for a garment wherein the waistband further includes an inner portion and an outer portion, and wherein the at least one fighting belt material is integrated into the waistband between the inner portion and the outer portion of the waistband.

The present disclosure also provides for a garment wherein the at least one fighting belt material is secured with respect to the at least one portion of the least one garment surface by stitching or sewing.

The present disclosure also provides for a fishing garment system including at least one garment, at least one fighting belt material secured with respect to at least one portion of the at least one garment, a first end fastener fastened to the at least one fighting belt material, a second end fastener fastened to the at least one fighting belt material, and each of the first and second end fasteners configured and dimensioned to releasably fasten to a fish fighting article. The present disclosure also provides for a fishing garment system wherein the at least one garment is selected from the group consisting of a pair of shorts, pants, overalls, bibs and capris.

The present disclosure also provides for a fishing garment system wherein the form of the at least one fighting belt material is selected from the group consisting of nylon, braided nylon, polypropylene, polyester, polyethylene, leather, cotton and combinations thereof. The present disclosure also provides for a fishing garment system wherein the first and second end fasteners are selected from the group consisting of D-rings, releasable snap-on fasteners, releasable clip-on fasteners, releasable button-on fasteners, zip-on fasteners, releasable strap-on fasteners, Velcro® fasteners and combinations thereof.

The present disclosure also provides for a fishing garment system wherein the fish fighting article is selected from the group consisting of a releasable fish fighting plate, releasable fish fighting harness, releasable fish fighting belt, releasable fish fighting belt material, releasable fishing rod receiving portion, and releasable fish fighting gimbal. In one embodiment, the present disclosure also provides for a fishing garment system wherein the fish fighting article is a releasable fish fighting plate, and wherein the releasable fish fighting plate further includes a plastic fishing rod receiving portion, and wherein the plastic fishing rod receiving portion includes a gimbal portion.

The present disclosure also provides for a fishing garment system further including a first recessed pocket positioned on the at least one garment to allow the first end fastener to be tucked into the first recessed pocket, and a second recessed pocket positioned on the at least one garment to allow the second end fastener to be tucked into the second recessed pocket.

In one embodiment, the present disclosure also provides for a fishing garment system wherein the at least one garment includes a waistband, and wherein the at least one fighting belt material is secured with respect to the back and side portions of the waistband. The present disclosure also provides for a fishing garment system wherein the waistband further includes an inner portion and an outer portion, and wherein the at least one fighting belt material is integrated into the waistband between the inner portion and the outer portion of the waistband. The present disclosure also provides for a fishing garment system wherein the at least one fighting belt material is secured with respect to the at least one portion of the least one garment by stitching or sewing.

Additional advantageous features, functions and applications of the disclosed fishing garment systems/designs will be apparent from the description which follows, particularly when read in conjunction with the appended figures.

### BRIEF DESCRIPTION OF FIGURE(S)

To assist those of skill in the art in making and using the disclosed fishing garment systems/designs, reference is made to the accompanying figures, wherein:

FIG. 1A is a front view of an exemplary pair of shorts that includes an integrated fighting belt material according to the present disclosure;

FIG. 1B is a back view of an exemplary pair of shorts that includes an integrated fighting belt material according to the present disclosure;

FIG. 2 is a partial side view of an exemplary pair of shorts that includes an integrated fighting belt material according to the present disclosure; and

FIG. 3 is a front view of a exemplary releasable fish fighting article for use with the fishing garment design according to the present disclosure.

### DESCRIPTION OF EXEMPLARY EMBODIMENT(S)

The present disclosure provides for an advantageous fishing garment system/design that facilitates ready access to fish fighting articles or gear. In an exemplary embodiment, the present disclosure provides for a fishing garment design that includes attachment features for releasably securing fish fighting articles or gear to the fishing garment design. In one embodiment, the present disclosure provides for a fishing garment design that includes attachment features for releasably securing fish fighting articles or gear to the fishing garment design, and where the fish fighting articles or gear is easily adjusted by the user once the fighting articles or gear is secured onto the fishing garment design. The disclosed fishing garment design is particularly adapted for use in connection with big-game fishing, e.g., sportfishing, salt and freshwater offshore fishing, billfish fishing, tuna fishing, sharkfishing or the like.

For example, the present disclosure provides for an advantageous fishing garment system/design that facilitates ready access to fish fighting articles or gear when the fisherman is confronted with the need to secure or unsecure fighting articles or gear around their body in a short period of time under adverse conditions, e.g., while standing on a boat that is in motion and/or rocking, attempting to secure or unsecure the fighting gear with one arm while the other arm is engaged in some other activity, attempting to secure or unsecure the fighting gear in adverse weather conditions, etc. Current practice with fish fighting articles or gear allows for a risk that a fisherman may experience difficulty in securing or unsecuring the fighting articles or gear around the fisherman's body, thereby placing the fisherman at risk of wasting valuable fishing time and/or losing a fish on the line. The present disclosure provides for a fishing garment design that includes attachment features for quickly securing or unsecuring fish fighting articles or gear to the fishing garment design, even under adverse conditions. The present disclosure also provides for a fishing garment design where the fish fighting articles or gear is easily adjusted by the user once the fighting articles or gear is secured onto the fishing garment design, even under adverse conditions.

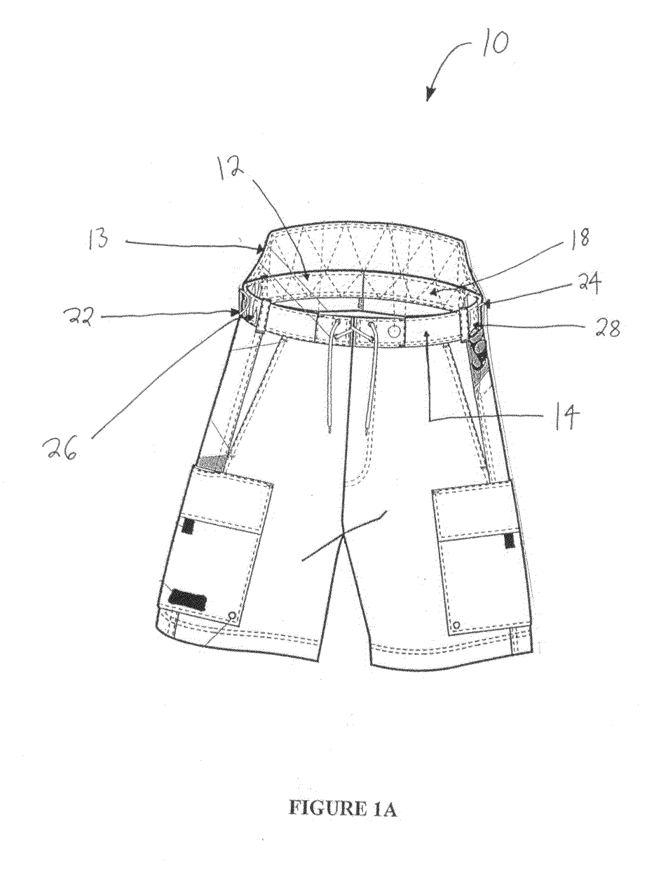

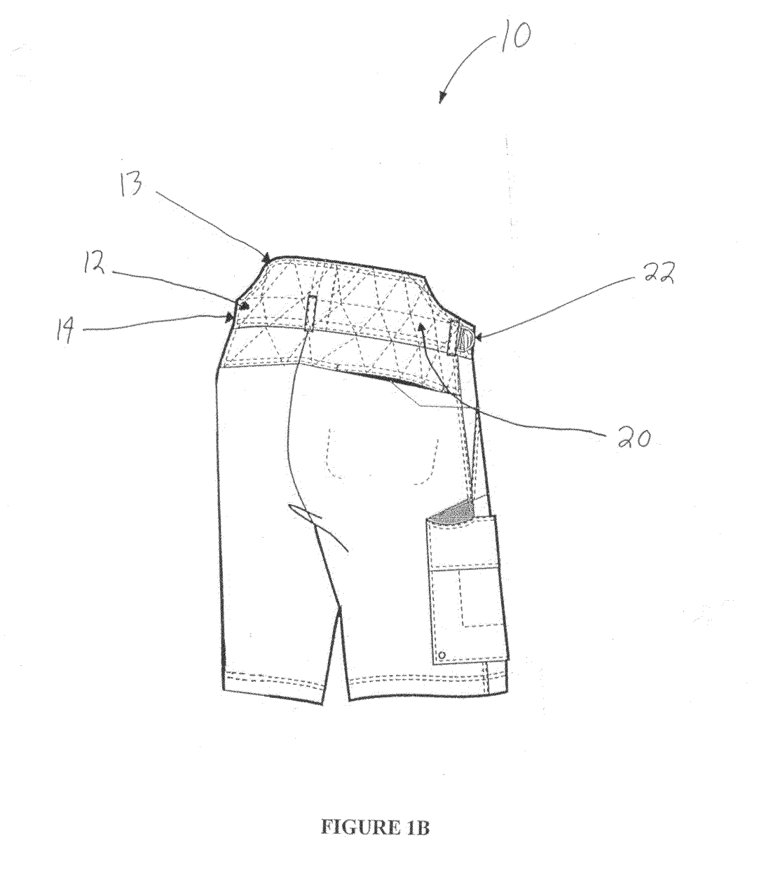

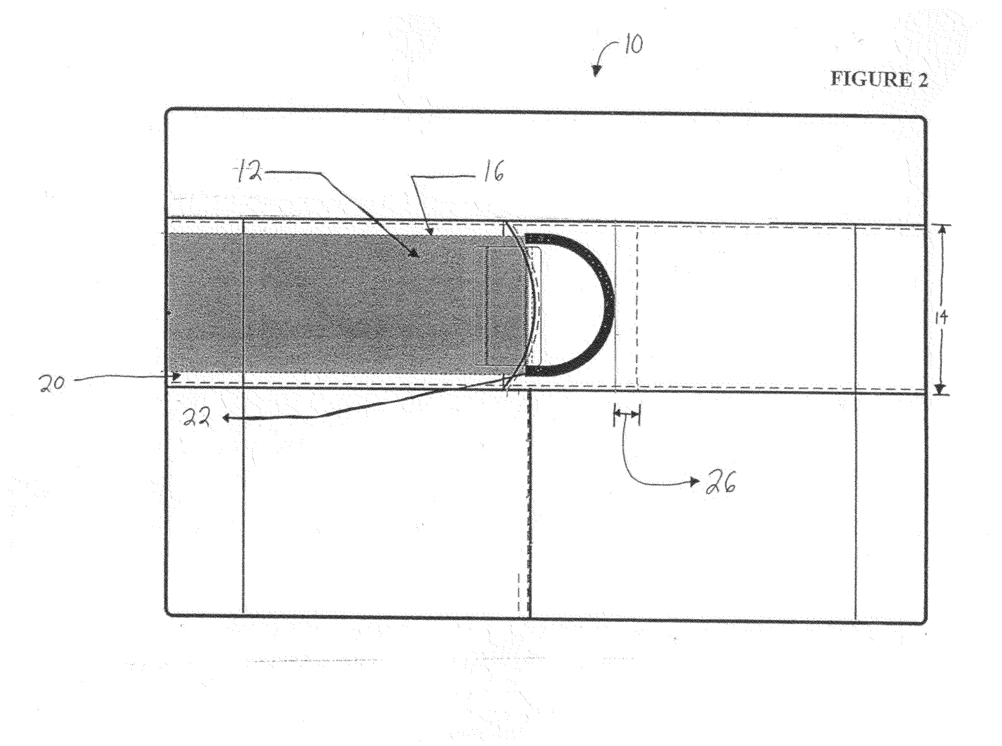

With reference to FIGS. 1A, 1B and 2, an exemplary garment design 10 is depicted with fighting belt material 12 positioned in the back and side regions thereof. Exemplary garment 10 takes the form of a pair of shorts, although the present disclosure is not limited thereto. Rather, garment 10 may take a variety of forms, including without limitation, pants, overalls, bibs, capris or the like. In an exemplary embodiment of the present disclosure, garment 10 takes the form of a pair of quick dry nylon shorts. The quick dry nylon shorts may or may not be stain and/or tear resistant. In an exemplary embodiment and as depicted in FIGS. 1A and 1B, garment 10 includes reinforced back support section 13.

As shown in FIGS. 1A, 1B and 2, fighting belt material 12 is positioned in the back and side regions of garment 10. In an exemplary embodiment of the present disclosure, fighting belt material 12 is secured with respect to the back and side portions of the waistband 14 of garment 10. Alternatively, fighting belt material 12 could be repositioned on garment 10 with the fighting belt material 12 secured with respect to the buttock or leg regions of garment 10, or to a variety of alternative anatomical locations, e.g., in the back and side torso regions of garment 10.

In an exemplary embodiment and as shown in FIGS. 1A, 1B and 2, fighting belt material 12 is shown sewn into the back and side portions of the waistband 14 of garment 10. In one embodiment of the present disclosure, fighting belt material 12 is secured with respect to garment 10 by stitching or sewing fighting belt material 12 into the back and side portions of the waistband 14 of garment 10. In one embodiment of the present disclosure and as shown in FIG. 2, fighting belt material 12 is stitched or sewn into the back and side portions of the waistband 14 of garment 10 using heavy embroidery thread. Other types of threading material could be used, for example, polyester thread, nylon thread, sewing thread or the like. Alternatively, fighting belt material 12 could be secured with respect to garment 10 using a variety of methods and/or materials, e.g., zippers, buttons, clip-ons, clasps, iron-on, Velcro® fasteners or the like.

In one embodiment of the present disclosure and as depicted in FIGS. 1A, 1B and 2, fighting belt material 12 is integrated into the waistband 14 of garment 10 between the inner portion 18 of waistband 14 and the outer portion 20 of waistband 14. In an alternative embodiment, fighting belt material 12 could be secured with respect to garment 10 by securing fighting belt material 12 onto the inner portion 18 of waistband 14. In another alternative embodiment, fighting belt material 12 could be repositioned in garment 10 by securing fighting belt material 12 onto the outer portion 20 of waistband 14.

In an exemplary embodiment and as depicted in FIGS. 1A, 1B and 2, fighting belt material 12 takes the form of a nylon material, although the present disclosure is not limited thereto. Rather, fighting belt material 12 may take a variety of forms, including without limitation, braided nylon, polypropylene, polyester, polyethylene, leather, cotton or the like.

In one embodiment and as depicted in FIGS. 1A and 1B, fighting belt material 12 is a continuous strip of material that is secured with respect to garment 10. In an alternative embodiment, fighting belt material 12 is a discontinuous strip of material that is secured with respect to garment 10. For example, garment 10 may include two or three sections of fighting belt material 12 that are secured with respect to garment 10. In another embodiment of the present disclosure, garment 10 includes several sections of fighting belt material 12 that are secured with respect to garment 10.

In an exemplary embodiment of the present disclosure and as shown in FIGS. 1A, 1B and 2, fighting belt material 12 includes end fasteners 22 and 24. End fasteners 22, 24 may be fastened to fighting belt material 12 at any location of fighting belt material 12. In one embodiment and as depicted in FIGS. 1A, 1B and 2, end fasteners 22, 24 are fastened at or near each terminal end of fighting belt material 12.

In an exemplary embodiment of the present disclosure, end fasteners 22, 24 take the form of D-rings, although the present disclosure is not limited thereto. Rather, end fasteners 22, 24 may take a variety of forms, including without limitation, releasable snap-on fasteners, releasable clip-on fastener, releasable button-on fasteners, zip-on fasteners, releasable strap-on fasteners, Velcro® fasteners or the like. In one embodiment of the present disclosure, end fasteners 22, 24 take the form of rustproof and/or corrosion proof D-rings.

In an exemplary embodiment of the present disclosure and as depicted in FIGS. 1A and 2, garment 10 includes recessed pockets 26 and 28. In an exemplary embodiment, recessed pocket 26 is positioned on garment 10 so that end fastener 22 may be tucked into recessed pocket 26 when end fastener 22 is not releasably fastened to fish fighting gear, and recessed pocket 28 is positioned on garment 10 so that end fastener 24 may be tucked into recessed pocket 28 when end fastener 24 is not releasably fastened to fish fighting gear. For example, a fisherman wearing garment 10 may tuck end fasteners 22, 24 into recessed pockets 26, 28 for style or fashion reasons, for example, when the fisherman does not wish to utilize garment 10 to releasably secure fish fighting gear to the garment 10, e.g., when the fisherman is not fishing. However, when the fisherman does wish to utilize garment 10 to releasably secure fish fighting gear to the garment 10, the fisherman may untuck end fasteners 22, 24 from the recessed pockets 26, 28 so that the end fasteners 22, 24 are available to releasably fasten to fish fighting gear.

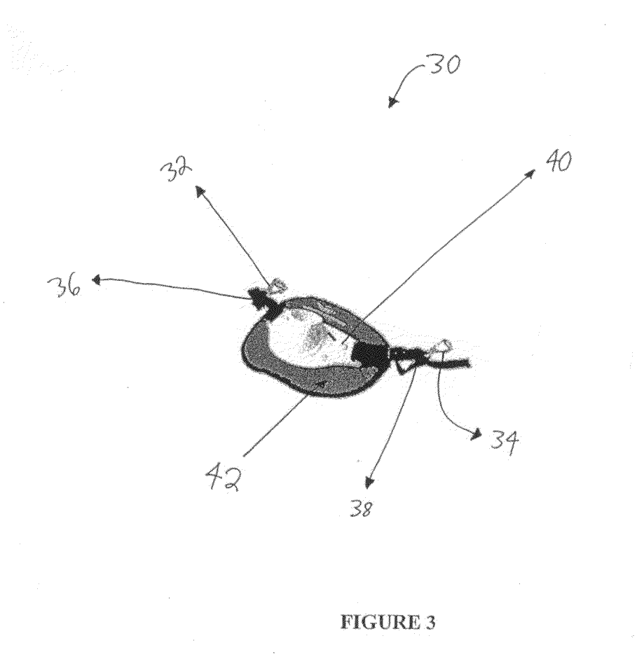

With reference to FIG. 3, an exemplary fish fighting article 30 for use with the garment system/design 10 is depicted. In one embodiment of the present disclosure, fish fighting article 30 takes the form of a releasable fish fighting plate, although the present disclosure is not limited thereto. Rather, fish fighting article may take a variety of forms, including without limitation, a releasable fish fighting harness, releasable fish fighting belt, releasable fish fighting belt material, releasable fishing rod receiving portion, releasable fish fighting gimbal or the like.

In an exemplary embodiment and as shown in FIG. 3, releasable fish fighting article 30 includes belt fasteners 32 and 34. In one embodiment, belt fasteners 32, 34 take the form of releasable clip-on fasteners, although the present disclosure is not limited thereto. Rather, belt fasteners 32, 34 may take a variety of forms, including without limitation, D-rings, releasable snap-on fasteners, releasable button-on fasteners, zip-on fasteners, releasable strap-on fasteners, Velcro® fasteners or the like.

In an exemplary embodiment and as shown in FIG. 3, fish fighting article 30 includes elongated strips 36 and 38. In one embodiment, elongated strips 36, 38 are fabricated in whole or in part from nylon, although the present disclosure is not limited thereto. Rather, elongated strips 36, 38 may take a variety of forms, including without limitation, braided nylon, polypropylene, polyester, polyethylene, leather, cotton or the like. In an alternative embodiment, fish fighting article 30 includes a single elongated strip.

In an exemplary embodiment and as shown in FIG. 3, belt fastener 32 may be adjustably positioned at any location along the length of elongated strip 36, and belt fastener 34 may be adjustably positioned at any location along the length of elongated strip 38. In an alternative embodiment, fish fighting article 30 includes a single elongated strip, and belt fasteners 32, 34 may be adjustably positioned at any location along the length of the elongated strip.

In an exemplary embodiment and as shown in FIG. 3, fish fighting article 30 includes a fishing rod receiving portion 40. In one embodiment, fishing rod receiving portion 40 takes the form of a plastic fishing rod receiving portion, although the present disclosure is not limited thereto. In one embodiment, fishing rod receiving portion 40 includes a gimbal portion, although the present disclosure is not limited thereto. In one embodiment, the fishing rod receiving portion further includes a removable pin for receiving an end portion of a fishing rod (not shown). In one embodiment, fishing rod receiving portion 40 is securedly attached to a plate portion 42. Plate portion may or may not be padded. In an exemplary embodiment, plate portion 42 is padded and further includes a PVC exterior material. In one embodiment of the present disclosure, plate portion 42 is padded and further includes a PVC exterior material, and plate portion 42 takes the form of a curved design.

In an exemplary embodiment and as shown in FIG. 3, elongated strip 36 is fastened to one end of fishing rod receiving portion 40, and elongated strip 38 is fastened to the other end of fishing rod receiving portion 40. In an alternative embodiment, elongated strip 36 is fastened to one end of plate portion 42, and elongated strip 38 is fastened to the other end of plate portion 42. In another alternative embodiment, elongated strip 36 is fastened to one end of fishing rod receiving portion 40 and to one end of plate portion 42, and elongated strip 38 is fastened to the other end of fishing rod receiving portion 40 and to the other end of plate portion 42.

In an alternative embodiment, fish fighting article 30 includes a single elongated strip, and plate portion 42 is fastened to the elongated strip. In another embodiment, fish fighting article 30 includes a single elongated strip, and fishing rod receiving portion 40 is fastened to the single elongated strip. In another embodiment, fish fighting article 30 includes a single elongated strip, and fishing rod receiving portion 40 and plate portion 42 are both fastened to the elongated strip.

In an exemplary embodiment and as shown in FIG. 3, fish fighting article 30 is releaseably fastened to the garment design 10 by releasably fastening end fastener 22 of garment 10 to belt fastener 32 of fish fighting article 30, and by fastening end fastener 24 of garment 10 to belt fastener 34 of fish fighting article 30. In one embodiment of the present disclosure, when the garment 10 is fastened to fish fighting article 30, the length of the elongated strips 36, 38 are adjustable by lengthening or shortening elongated strips 36, 38 with strip length adjusters (not shown). In an alternative embodiment, when the fish fighting article 30 includes a single elongated strip, and when the garment 10 is fastened to fish fighting article 30, the length of the elongated strip is adjustable by lengthening or shortening the elongated strip with strip length adjusters (not shown).

In an exemplary embodiment, once the fish fighting article 30 is fastened to the garment 10 that is being worn by the user, the fish fighting article 30 may be tightened or loosened accordingly around the user's body by lengthening or shortening the elongated strips 36, 38 with strip length adjusters (not shown). In an exemplary embodiment, the fish fighting article 30 may be fastened quickly to garment 10 worn by the user, and the fish fighting article 30 may be quickly unfastened from garment 10 worn by the user, when desired. After the fish fighting article 30 is releasably fastened to garment 10 worn by the user, the user may utilize the fish fighting article 30 to help the user retrieve a fish. For example, if the user has a fish on the end of the line, the user may utilize fish fighting article 30 by placing the user's fishing rod into the fishing rod receiving portion 40 to help the user retrieve and/or land the fish.

Although the fishing garment systems/designs of the present disclosure have been described with reference to exemplary embodiments thereof, the present disclosure is not limited to such exemplary embodiments and/or implementations. Rather, the fishing garment systems/designs of the present disclosure are susceptible to many implementations and applications, as will be readily apparent to persons skilled in the art from the disclosure hereof. The present disclosure expressly encompasses such modifications, enhancements and/or variations of the disclosed embodiments.

1. A garment, comprising:
at least one garment surface;
at least one fighting belt material secured with respect to at least one portion of the at least one garment surface;
a first end fastener fastened to the at least one fighting belt material;
a second end fastener fastened to the at least one fighting belt material; and
each of the first and second end fasteners configured and dimensioned to releasably fasten to a fish fighting article.

2. A garment according to claim 1, wherein the at least one garment surface is associated with a garment selected from the group consisting of a pair of shorts, pants, overalls, bibs and capris.

3. A garment according to claim 1, wherein the form of the at least one fighting belt material is selected from the group consisting of nylon, braided nylon, polypropylene, polyester, polyethylene, leather, cotton and combinations thereof.

4. A garment according to claim 1, wherein the first and second end fasteners are selected from the group consisting of D-rings, releasable snap-on fasteners, releasable clip-on fasteners, releasable button-on fasteners, zip-on fasteners, releasable strap-on fasteners, Velcro® fasteners and combinations thereof.

5. A garment according to claim 1, wherein the fish fighting article is selected from the group consisting of a releasable fish fighting plate, releasable fish fighting harness, releasable fish fighting belt, releasable fish fighting belt material, releasable fishing rod receiving portion, and releasable fish fighting gimbal.

6. A garment according to claim 1, wherein the fish fighting article is a releasable fish fighting plate, and wherein the releasable fish fighting plate further includes a plastic fishing rod receiving portion, and wherein the plastic fishing rod receiving portion includes a gimbal portion.

7. A garment according to claim 1, further comprising a first recessed pocket positioned to allow the first end fastener to be tucked into the first recessed pocket, and a second recessed pocket positioned to allow the second end fastener to be tucked into the second recessed pocket.

8. A garment according to claim 1, wherein the at least one garment surface is a waistband, and wherein the at least one fighting belt material is secured with respect to the back and side portions of the waistband.

9. A garment according to claim 8, wherein the waistband further includes an inner portion and an outer portion, and wherein the at least one fighting belt material is integrated into the waistband between the inner portion and the outer portion of the waistband.

10. A garment according to claim 1, wherein the at least one fighting belt material is secured with respect to the at least one portion of the least one garment surface by stitching or sewing.

11. A fishing garment system, comprising:
at least one garment;
at least one fighting belt material secured with respect to at least one portion of the at least one garment;
a first end fastener fastened to the at least one fighting belt material;
a second end fastener fastened to the at least one fighting belt material; and
each of the first and second end fasteners configured and dimensioned to releasably fasten to a fish fighting article.

12. A fishing garment system according to claim 11, wherein the at least one garment is selected from the group consisting of a pair of shorts, pants, overalls, bibs and capris.

13. A fishing garment system according to claim 11, wherein the form of the at least one fighting belt material is selected from the group consisting of nylon, braided nylon, polypropylene, polyester, polyethylene, leather, cotton and combinations thereof.

14. A fishing garment system according to claim 11, wherein the first and second end fasteners are selected from the group consisting of D-rings, releasable snap-on fasteners, releasable clip-on fasteners, releasable button-on fasteners, zip-on fasteners, releasable strap-on fasteners, Velcro® fasteners and combinations thereof.

15. A fishing garment system according to claim 11, wherein the fish fighting article is selected from the group consisting of a releasable fish fighting plate, releasable fish fighting harness, releasable fish fighting belt, releasable fish fighting belt material, releasable fishing rod receiving portion, and releasable fish fighting gimbal.

16. A fishing garment system according to claim 11, wherein the fish fighting article is a releasable fish fighting plate, and wherein the releasable fish fighting plate further includes a plastic fishing rod receiving portion, and wherein the plastic fishing rod receiving portion includes a gimbal portion.

17. A fishing garment system according to claim 11, further comprising a first recessed pocket positioned on the at least one garment to allow the first end fastener to be tucked into the first recessed pocket, and a second recessed pocket positioned on the at least one garment to allow the second end fastener to be tucked into the second recessed pocket.

18. A fishing garment system according to claim 11, wherein the at least one garment includes a waistband, and wherein the at least one fighting belt material is secured with respect to the back and side portions of the waistband.

19. A fishing garment system according to claim 18, wherein the waistband further includes an inner portion and an outer portion, and wherein the at least one fighting belt material is integrated into the waistband between the inner portion and the outer portion of the waistband.

20. A fishing garment system according to claim 11, wherein the at least one fighting belt material is secured with respect to the at least one portion of the least one garment by stitching or sewing.
